(19) United States
(12) Patent Application Publication
(10) Pub. No.: US 2010/0106572 A1
(43) Pub. Date: Apr. 29, 2010

(54) ACCESS POINT ADVERTISING

(75) Inventors: Arthur Anthonie van Hoff, Menlo Park, CA (US); David Zachary Creemer, Palo Alto, CA (US)

Correspondence Address: Workman Nydegger;1000 Eagle Gate Tower, 60 East South Temple, Salt Lake City, UT, 84111, US

(73) Assignee: Dell Products L.P., Round Rock, TX (US)

(21) Appl. No.: 12/258,011

(22) Filed: Oct. 24, 2008

(51) Int. Cl. G06Q 30/00; H04W 4/00

(52) U.S. Cl. 705/14.4; 370/338

(57) ABSTRACT

Systems and methods for providing advertisement supported free access to a network. An access point of the network may provide advertisements to a media device for viewing prior to free access being granted. Alternatively, the advertisements may reside on the media device for viewing prior to free access being granted.

### CROSS-REFERENCE TO RELATED APPLICATIONS

Not applicable.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems are often involved in the distribution of digital media. Today, high quality digital media can be delivered over various types of networks in relatively short time frames. As a result, content such as music, video, Internet data, sports, news, weather, and the like, can be distributed to and performed by a growing number of diverse devices including MP3 players, portable CD players, portable DVD players, notebook computers, cellular telephones, personal digital assistants (PDAs), and the like. Digital media can also be enjoyed on non-portable devices as well such as on desk top computers.

The various types of networks and devices present challenges for information handling systems. When connecting to a network, such as a public WiFi network, the user of a device may encounter difficulties in connecting to the network and in accessing content over the network. Often, a user may be required to pay an access fee in order to access the network. As will be appreciated, the access fees are often necessary to provide an income source for the network provider and cover costs. In addition, any user who attempts the access the network is often taken to a captive portal where payment or proof of payment such as a password and username is required before access to the network is granted. This can be an annoyance to the user and may prevent or discourage many users from accessing the network.

### BRIEF SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

An embodiment disclosed herein relates to a method for an access point to provide advertisement data to be viewed at a media device in order to support free access to a network. The method may be practiced in a system including a media device that is configured to access a network through one or more network access points. The method comprises receiving a request from a media device for access to a network, in response to the request, selecting advertisement data from a memory that includes advertisement data, communicating the advertisement data to the media device, and providing the media device access to the network upon verification that the advertisement data has been viewed at the media device.

Another embodiment disclosed herein relates to a method for providing advertisement data at a media device in order to support free access to a network. The method may be practiced in a system including a media device that is configured to access a network through one or more network access points. The method comprises requesting that an access point provide access to a network, in response to the request, receiving instructions from the access point specifying that advertisement data should be viewed prior to access to the network being granted, selecting advertisement data in accordance with the received instructions, viewing the advertisement data, communicating to the access point that the advertisement has been viewed, and gaining access to the network.

Another embodiment disclosed herein relates to a media device configured to communicate with a network. The media device comprises a memory, a processing unit, a connection module configured to communicate with a network access point, and an advertisement module configured to select advertisement data in accordance with instructions received from the access point, wherein viewing the selected advertisement data allows access to be granted by the access point to a network without the need for a prior form of payment.

Additional features and advantages will be set forth in the description which follows, and in part will be obvious from the description, or may be learned by the practice of the teaching herein. The features and advantages of the teaching herein may be realized and obtained by means of the instruments and combinations particularly pointed out in the appended claims. These and other features will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 illustrates one embodiment of a schematic drawing of a media device;

FIG. 2 illustrates one embodiment of a system for providing access to a network for a media device;

FIG. 3 illustrates one embodiment of a flow chart of a method for providing an advertising supported access point to a network; and

FIG. 4 depicts one embodiment of a flow chart of a method for providing advertisement data at a media device in order to support access to a network.

### DETAILED DESCRIPTION

In the following detailed description, reference is made to the accompanying drawings which form a part hereof, and in which are shown by way of illustration specific embodiments in which the invention may be practiced. It is to be understood that other embodiments may be utilized and structural changes may be made without departing from the scope of the present invention.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

Embodiments of the invention relate to providing access points to a network for devices including media devices or other types of information handling systems. The access may be related to the delivery and performance of advertising content on the device. The advertising content can be specific to entities or locations associated with the access point, or may be related to user attributes, device attributes, network location, and the like. Typically, the advertising content is presented and access to the network is then granted to the device. The advertising content can be presented prior to granting access, while the device accesses the network, or in any other manner.

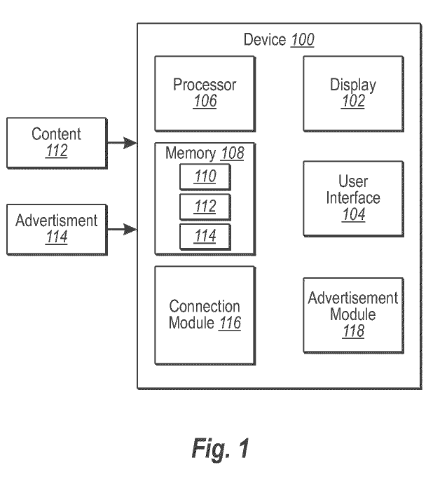

FIG. 1 illustrates an embodiment of a media device 100 that can receive content including digital media from one or more sources. Examples of the media device 100 may include, by way of example, a satellite radio device, a portable audio and/or video player (e.g., MP3 player), a portable DVD or CD player, a personal computer, a laptop computer, a server computer, a cellular telephone, a personal digital assistant (PDA), and the like or any combination thereof Embodiments of the invention practiced in portable media devices, but one of skill in the art can appreciate that embodiments of the invention can be used with other media devices able to receive and render media content.

Typically, the media device 100 includes a display 102 that can convey information to a user of the media device. For example, when the media device 100 renders digital audio data, the display 102 may indicate the song title, the artist, the album title, the track number, the length of the track, and the like or any combination thereof.

The media device 100 also includes a user interface 104 (such as control buttons, touch screen, capacitive input, etc.) or other means of providing input to the media device 100. The user interface 104, by way of example, enables a user to navigate, activate, and/or perform the digital media and other content that may be stored in the memory 108 of the media device 100 or to navigate and perform any digital media or content that is received from an external source. The user interface 104 may enable a user to switch to another channel, such as in satellite radio, or otherwise select media content. The media device 100 may be able to receive content over various networks and may perform the content in real-time or by time shifting the content.

The media device 100 may further include a processor 106. The processor 106 by way of example, enables media device 100 to execute various programs as circumstances warrant. In addition, the processor 106 may be utilized by one or more of the other modules or elements of media device 100 for processing operations.

The memory 108 of the media device 100, which may include volatile and non-volatile memory or any combination thereof, can be used to store content or other user and/or device data. The memory 108, for example, may store digital music and/or video, graphics, play lists, user preferences, device settings, and the like or any combination thereof As will be described in more detail to follow, the memory 108 may also store various advertisement data and the like. The memory 108 may store user attributes 110.

The user attributes 110 may include information about the user of media device 100. For example, the user attributes 110 may include demographic information such as gender, age, address, and occupation of the user. The user attributes 110 may also include various interests of the user such as favorite hobbies, books, music, sports, and the like. This information may be used to target advertisements for the user as will be explained in more detail to follow. In some embodiments, the user information 110 may be entered into memory 108 at the time the user purchases media device 100. In other embodiments, the user information 100 may be occasionally updated to ensure that the information is up to date. In certain embodiments, the media device 100 may infer user attributes from the way the media device is used or from the content that is performed by the media device, the channels selected by the user, the websites accessed by the user, and the like. Further, the user attributes may be uploaded to a server computer such that content delivered to the media device over a network may be influenced by the user attributes.

The content 112 represents different types of media including digital media that may be received by the media device 100. Examples of the content 112 include, but are not limited to, digital music, talk audio data, television data, movie data, podcasts, sports data, weather data, news data, Internet data, and the like or any combination thereof The content 112 can be either digital or analog in nature and may be stored in memory 108 upon being received by media device 100. In some embodiments, the media device may convert analog content to digital content. The media device 100 may also convert the format of the content to another format.

The advertisements 114 represent different types of advertisements that may be received by media device 100. The advertisements 114 may include, but are not limited to, audio and visual advertisements. The types of advertisements 114 that are received by the media device 100 may be at least partially determined by the user attributes 110. The advertisements 114 may be stored in memory 108 upon being received by media device 100. Alternatively, the advertisements 114 can be delivered to the media device 100, but the advertisements actually presented to a user may be selected using user attributes, device characteristics, and/or environmental factors such as the time of day or location of the media device. Further, the advertisements 114 can be refreshed using available networks such that the advertisements presented to the user do not become stale.

Media device 100 may also include one or more additional modules configured to allow media device 100 to access a network such as the Internet. It will be appreciated that such modules may be comprised of software, hardware, or any combination of hardware and software. Further, these modules may be separate modules or they may be part of one or more modules.

For example, media device 100 may include a connection module 116. Connection module 116 may be configured to facilitate the connection of media device 100 with one or more access points of a network. The media device 100 may also include an advertisement module 118. Advertisement module 118 may be configured to select various advertisements 114 stored in memory 108. The advertisement module 118 may also be configured to identify and download advertising content to the media device 100.

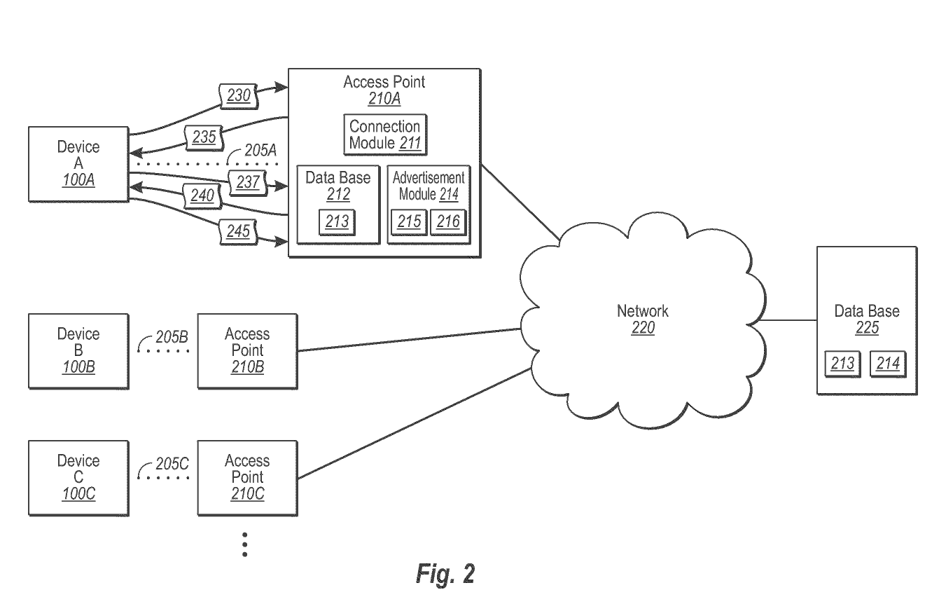

FIG. 2 illustrates one example of an environment 200 for implementing embodiments of the invention. FIG. 2 shows media devices 100A, 100B, and 100C (also referred to as media devices 100) that are configured to access a network 220 through one or more access points 210A, 210B, and 210C (also referred to as access points 210) as illustrated by dots 205A, 205B, and 205C. Although illustrated as a wireless network, the environment 200 may also be implemented as a wired network. The media devices 100 may include, for example, any of the media devices described in reference to FIG. 1. The network 220 may be the Internet or some other wide area network that may be accessed through one or more access points.

The access points 210 can be representative of various access points or “hotspots” that may be used to access the network 220. The access points 210 represent any network that is compatible with the media devices 100 and may include, by way of example, satellite networks, 802.11 networks, personal computer networks (e.g., LAN, WAN), wireless networks (e.g., Bluetooth, WiFi), cellular networks, telephony networks (e.g., landline or PSTN), data networks, and the like or any combination thereof As illustrated, the access points 210 may provide the media devices 100 with the content 112 previously discussed. As will be appreciated, the access points 210 include all of the hardware, software, and the like necessary for the media devices 100 to connect with network 220.

In some embodiments, access points 210A, 210B and 210C may all be part of a network owed by a single entity. For example, these access points may all be part a network owned and operated by a telecommunications carrier that maintains access points that are geographically dispersed. In other embodiments, the access points 210A, 210B, and 210C may be individual local area networks or the like owned and operated by more than one entity. Further, the access points 210 may be geographically diverse. For example, one or more of the access points 210 may be located in a specific geographic location, such as a particular building or place of business while another of the access points 210 may be located in a different building in another part of a city.

As previously described, typically a user must pay some type of access fee when utilizing an access point 210 to connect to network 220. Advantageously, the principles of the present invention allow the user to first access one or more advertisements in exchange for limited, free access to network 220 via access points 210.

As shown, access point 210A includes a connection module 211. Connection module 211 is configured to communicate with a media device 100 in order to facilitate the connection between the media device 100 and the access point 210A. The connection module 211 may be hardware, software, or any combination of hardware and software.

The access point 210A also includes a database 212, which may be any reasonable database or memory. Alternatively, the access point 210A may have access to an external global database 225 that may be accessible by all of the access points 210. The database 212 or 225 may include one or more advertisements 213. The advertisements 213 may include audio and/or visual content and may be of any format known to those of skill in the art including, but not limited to mp3, AAC, WAV, WMA, AAC+, QuickTime, Real Audio, RealPlayer Presentation and the like. The advertisements 213 may include advertisement information directed towards particular products or services. This advertisement information may also include advertisements directed towards events, destinations, local happenings and the like. The advertisements 213 may also have geographic attributes that may allow a particular advertisement, for example, to be associated with a specific access point. It will be appreciated that the advertisements 213 may include information on numerous subjects that are commonly advertised.

The access point 210A further includes an advertisement module 214. Advertisement module 214 may be configured to select one or more advertisements 213 to be provided to a media device 100 as will be explained in more detail. In still other embodiments, the advertisement module 214 may access the global database 225 that also includes one or more advertisements 213. The advertisement module 214 may be hardware, software, or any combination of hardware and software and further the advertisement module 214 may be part of the connection module 211 previously described.

In still other embodiments, the advertisement module 214 may be located at in a different portion of network 220. For instance, the advertisement module 214 may be included in the system or systems hosting database 225. Accordingly, the principles of the present invention contemplate having various modules distributed across network 220 and the illustration of a module in access point 210 is for ease of illustration only.

In some embodiments, advertisement module 214 may include one or more rules 215. The rules 215 may specify which advertisements 213 should be selected by the advertisement module 214 and how long such advertisement should play before complete access to the network is provided. In addition, the rules 215 may also specify how long content or access to the network will be provided to media device 100 before an additional advertisement must be viewed. Further, the rules 215 may specify the types of content that may be provided to the media device 100. In some instances, the content is free in the sense that no fee is required from the user of the media device.

As will be appreciated, the rules 215 may be determined by the owner of the access point 210A or by the owner of another location hosting advertisement module 214. In one example, the term “view” or “viewed” when referring to an advertisement refers to, but is not limited to, visually viewing a video advertisement and/or listening to an audio advertisement. In other words, viewing an advertisement is meant to cover any interaction or access a user of a device has with an advertisement or with access to a network.

In operation, access point 210A, specifically connection module 211, may receive a request 230 for access to network 220 from a media device 100 such as media device 100A. In response, connection module 211 may request 235 that the user of the media device 100 views an advertisement 213 in order to access the network. In other embodiments, a choice may given to the user of media device 100 to provide proof of previous payment such as a user name and password or to listen to or watch the advertisement 213. The interaction between the access point 210A and the media device 100 may be implemented using the Wireless Internet Service Provider roaming (WISPr) protocol. Currently, this protocol allows for an access point to ask for the password and username. However, this protocol may be modified in accordance with the principles of the present invention to allow for the option of accessing the advertisement so that the media device 100 may access the network 220 for free. Of course, other types of protocols may also be used when practicing the principles of the present invention.

If the user of media device 100 desires to access the network for free, he or she will cause media device 100 to respond to connection module 211 of access point 210A requesting that the advertisement 213 be provided to the media device 100 as illustrated at 237. Upon receiving the request 237 for the advertisement, connection module 211 will cause the advertisement module 214 to select one or more advertisements 213 in accordance with the rules 215. The selected advertisements may then be provided to the media device 100 as illustrated at 240. Once the media device 100 provides verification as illustrated at 245 that the advertisement 213 has been viewed or listened to by the user of media device 100, access point 210A will allow access to the network 220.

As will be appreciated, it may not be as beneficial to the owner of access point 210A to allow continuous access after the user views the initial advertisement 213. Accordingly, advertisement module 214 may also include or have access to a timer 216. Timer 216 may be configured to determine how long a media device 100 has accessed network 220 for free. When the free access exceeds an amount of time specified by the rules 215, for example an hour, the advertisement module 214 may be configured to notify connection module 211. Connection module 211 may then suspend the access to the network 220.

In some embodiments, connection module 211 may then request that media device 100 views a subsequent advertisement 213 (i.e., an advertisement that is viewed after the first advertisement) in order to once again access the network 220 for free. If the media device 100 accepts this request, a subsequent advertisement 213 will be selected and provided to the media device 100 and access to network 220 will be facilitated or resumed upon completion of the advertisement as previously described. This process may be repeated numerous times to ensure that the user of media device 100 views enough advertisements to at least offset some of the costs associated with accessing the network.

As will be appreciated, there are numerous ways that the rules 215 may specify how advertisements 213 are selected by the advertisement module 214. For example, in one embodiment the rules 215 may direct all of the access points 210 to provide the same advertisements 213 any time a media device 100 desires free access to network 220. For instance, a national retailer may pay the owner of the access points 210 to provide advertisements 213 directed towards the national retailer's products prior to allowing the free access. These advertisements may be placed in database 225 so that all of the access points 210 may access the advertisements. If a subsequent advertisement 213 is required for continued free access as described above, then the subsequent advertisement 213 may advertise a different product of the national retailer than was advertised in the first advertisement.

In another embodiment, the rules 215 may specify that each access point provide localized advertisements that are relevant to the location of the access point. For example, suppose that access point 210A were located at a particular retailer. The access point 210A may then provide advertisements 213 that are specific to the products of the specific retailer when access to the network is desired. As discussed above, the advertisements may be cycled to ensure that different products are advertised. Further, the manager (or other person or entity) of the retailer housing the access point 210A may access a web-page or other interface provided by access point 210A to upload various advertisements into database 212. If the access point 210A were owned by an entity other than the retailer that housed the access point, then a financial arrangement could be worked out by the two parties regarding the advertisements.

In still other embodiments, the rules 215 may specify that all access points 210 owned by one entity that reside in a particular business provide advertisements relevant to that business while other access points 210 owned by the same entity residing in another business provide advertising relevant to the other business. For example, suppose that access points 210A and 210B resided in a coffee outlet while access point 210C resided in a restaurant. The rules 215 may specify that access points 210A and 210B provide coffee advertisements while access point 210C provided food advertisements. It will be appreciated that the principles of the present invention provide for numerous ways that the selection of advertisements 213 may be specified.

As has been described, in some embodiments the advertisement information may be stored at and/or provided by the access point when a media device 100 desires to access network 220 for free. However, in alternative embodiments, the advertisement information may already be stored on media device 100.

As previously described in relation to FIG. 1, the media devices 100 may receive advertisements 114 from various sources such as national advertisers or local advertisers. As also described, the media devices 100 may include both a connect module 116 and an advertisement module 118 that may be utilized by an access point 210 in accordance with the principles of the present invention as will now be described.

For example, in operation, the connection module 116 may request that access point 210A provide access to the network 220. In response, the access point 210A may respond by requesting that the user of media device 100 view an advertisement in order to have free access. This interaction may be accomplished as described using the WISPr protocol or some other suitable protocol.

Upon receipt of the request to view or listen to an advertisement, the advertisement module 118 will select one or more advertisements 114 that are stored in memory 108. The selected advertisements may then be viewed by user of media device 100, after which free access to network 220 will be granted by access point 210A.

In some embodiments, access point 210A may be configured to specify which advertisements 114 should be selected by advertisement module 118. For example, in such embodiments the request from access point 210A may include information that directs advertisement module 118 to select particular advertisements 114.

For example, the access point 210A may specify that advertisement module 118 select advertisements 114 that are directed towards a national retailer that may not be relevant to the location of the access point. As described above, the third party retailer may pay the owner of access points 210 to specify which advertisements will be selected.

Likewise, the access point 210A may specify that advertisement module 118 select localized advertisements that are relevant to the location of the access point. As described above, the manager of the retailer housing the access point 210A may configure access point 210A to specify the desired advertisements 114. A fee for this service may be charged in the owner of the access point 210A is an entity other than the manager of the retailer housing the access point.

It will be appreciated that there may be circumstances when the desired advertisements 114 are not already be stored in memory 108 and therefore will not be available to be selected by advertisement module 118. In such embodiments, this may be communicated by connection module 116. The rules 215 of access point 210A may include default rules that specify alternative advertisements that should then be selected by advertisement module 118. In some embodiments, these default rules may also specify that the originally desired advertisements be downloaded into memory 108 while media device 100 is connected to network 220. In this way, the desired advertisements will then be available for selection should the user of media device 100 desire continued access to network 220.

In still other embodiments, media device 100 may include user profiles 110 discussed above. The advertisement module 11 8 may use the user profiles to determine which advertisements 114 to select when the desired advertisements are not available. In addition, in some embodiments, the advertisements 114 may be interstitially placed between content 112 that is received by media device 100. Methods and systems for a media device to interstitially place advertisements are further described in commonly owned, co-pending U.S. patent application Ser. No. 12/257,963, filed Oct. 24, 2008, herein incorporated by reference in its entirety.

As described above, it may not be as beneficial to the owner of access point 210A to allow continuous free access after the user views the initial advertisement 114. Accordingly, connection module 116 may have access to timer 216 or access to another timer that determines how long media device 100 has accessed network 220 for free. When the free access exceeds an amount of time specified by the rules 215, for example an hour, connection module 116 may then suspend the access to the network 220. A request may then be received to view another advertisement 114, at the conclusion of which free access to network 220 may be restored.

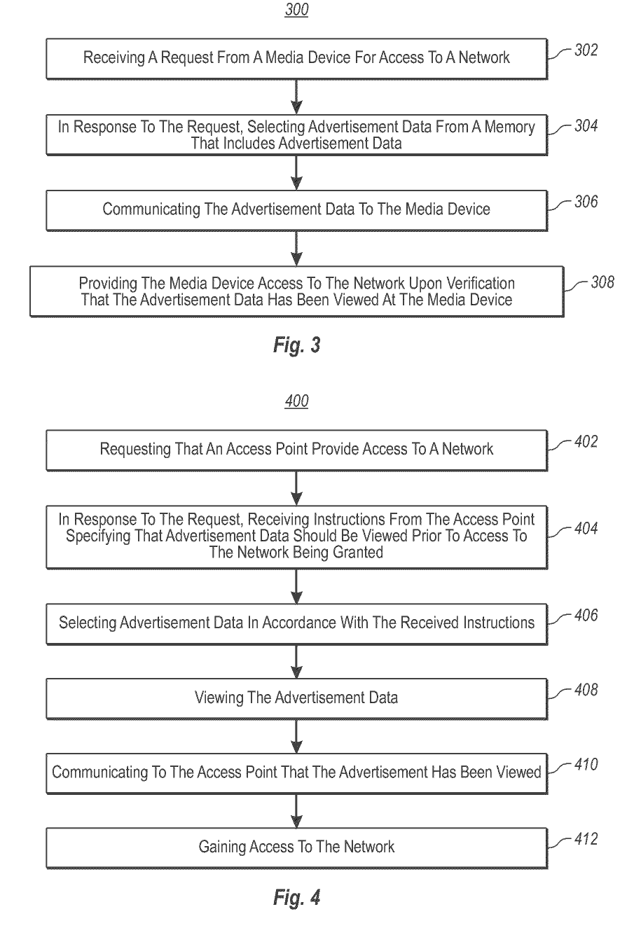

Reference is now made to FIG. 3, which illustrates a method 300 for an access point of a network to provide advertisement data to a media device that is configured to access the network through the access point in order to support access to the network. The method 300 includes receiving 302 a request from a media device for access to a network. For example, an access point such as access points 210 may receive a request from a media device 100 for access to network 220.

The method 300 also includes, in response to the request, selecting 304 advertisement data from a memory that includes advertisement data. For example, the access point 210A, specifically advertisement module 214, may access databases 212 or 225 to select the advertisement data 213. As previously described, the advertisement data 213 may be selected in accordance with one or more rules 215. The rules 215 may specify different types of advertisement data 213 such as the same advertisement 213 being selected by all access points in a network owned by the same entity or the selection of an advertisement 213 that is relevant to the location of a specific access point.

Method 300 further includes communicating 306 the advertisement data to the media device. For example, access point 210A, specifically connection module 211, may provide the selected advertisement data 213 to the media device 100.

The method 300 additionally includes providing 308 the media device access to the network upon verification that the advertisement data has been viewed at the media device. For example, once the media device 100 determines that the user has viewed the selected advertisement 213 in its entirety and has communicated this to access point 210A, the access point 210A will allow media device 100 to access network 220. The media device 100 may determine that a user has viewed the advertisement 213 when the advertisement has been fully performed. Alternatively, the advertisement 213 may be configured to require user input as the advertisement is performed. This can ensure that the advertisement is perceived by the user rather than simply performed by the device. For example, the advertisement may pause and wait for user input before continuing or the advertisement may require user input at some point during the advertisement. Once the advertisement is viewed, the access point 210A and the network 220 may provide various media content to the media device 100. The content can be automatically selected by the media device 100 or a user may navigate to specific content. Advantageously, the media device 100 is able to access the network 220 without the need to provide some type of payment as the advertisements will pay for the network access.

In other embodiments, the advertisement 213 may occupy a portion of the user interface continuously while the access point is used. This allows the user access to the network while advertisement content is presented at the same time.

Reference is now made to FIG. 4, which illustrates a method 400 for providing advertisement data at a media device that is configured to access a network through one or more network access points in order to support free access to the network. The method 400 includes requesting 402 that an access point provide access to a network. For example, a media device 100 specifically connection module 116, may request access to network 220 through access point 210A.

The method 400 also includes, in response to the request, receiving 404 instructions from the access point specifying that advertisement data should be viewed prior to access to the network being granted. For example, the device 100 may receive instructions from access point 210A specifying that advertisement data 114 should be viewed in order to gain access to network 220. These instructions may be received by connection module 116. A user may also opt out and pay a fee to gain access to the network.

The method 400 further includes selecting 406 advertisement data in accordance with the received instructions. For example, media device 100, specifically advertisement module 118, may select advertisements 114 that are stored in memory 108. As previously described, the advertisements 114 may be selected based on the rules 215 or upon the user attributes 110. The rules 215 may specify different types of advertisements 114 such as the same advertisement 114 being selected by all access points in a network owned by the same entity or the selection of an advertisement 114 that is relevant to the location of a specific access point.

The method 400 additionally includes viewing 408 the advertisement data and communicating 410 to the access point that the advertisement has been viewed. For example, the user media device 100 may view the selected advertisement 114 in its entirety. The connection module 116 may then communicate this to the access point 210A.

The method 400 further includes gaining 412 access to the network. For example, as previously described, the access point 210A will allow free access to the network 220 upon verification that that advertisement 114 has been viewed. At this point, the access point 210A and the network 220 may provide various media content to the media device 100.

Advantageously, the principles of the present invention allow for advertisement supported access to a network 220. In addition, the principles of the present invention allow for a third party advertiser to pay the owner of an access point to provide specific advertisements to a user of a media device 100 who desire free network access. In addition, embodiments of the present invention allow for media device based advertisements to be used to support free network access. Thus any media device by any manufacturer may be configured such that free access to the network may be achieved even if the media device and the access points have no prior relationships.

Embodiments herein may comprise a special purpose or general-purpose computer including various computer hardware. Media devices are examples of special purpose computers. Embodiments may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a system including a media device that is configured to access a network through one or more network access points, a method for the access points to provide advertisement data to be viewed at the media device in order to support free access to the network, the method comprising:
receiving a request from a media device for access to a network;
in response to the request, selecting advertisement data from a memory that includes advertisement data;
communicating the advertisement data to the media device; and
providing the media device access to the network upon verification that the advertisement data has been viewed at the media device.

2. The method in accordance to claim 1, further comprising:
communicating media content to the device after access to the network has been provided.

3. The method in accordance with claim 1 further comprising:
determining how long access to the network has been provided to the media device; and
suspending access to network when it is determined that the media device has accessed the network more than a predetermined amount of time.

4. The method in accordance with claim 3 further comprising:
selecting subsequent advertisement data from the database;
communicating the subsequent advertisement data to the media device; and
reestablishing access for the media device to the network upon verification that the subsequent advertisement data has been viewed at the media device.

5. The method in accordance with claim 1, wherein the advertisement data is selected based on one or more rules that specify how the advertisement data should be selected.

6. The method in accordance with claim 5, wherein the one or more rules specify that the same selected advertisement data be provided by all access points that provide network access to the media device.

7. The method in accordance with claim 5, wherein the one or more rules specify that the advertisement data that is selected is relevant to the location of the access point that provides access to the media device.

8. The method in accordance with claim 1, wherein the media device and the access point communicate using the WISPr protocol.

9. The method in accordance with claim 1, wherein the network is one of a satellite network, a 802.11 network, a computer network, a LAN, a wireless network, a WiFi network, a cellular network, a telephony network, or a data network.

10. In a system including a media device that is configured to access a network through one or more network access points, a method for providing advertisement data at the media device in order to support free access to the network, the method comprising:
requesting that an access point provide access to a network;
in response to the request, receiving instructions from the access point specifying that advertisement data should be viewed prior to access to the network being granted;
selecting advertisement data in accordance with the received instructions;
viewing the advertisement data;
communicating to the access point that the advertisement has been viewed; and
gaining access to the network.

11. The method in accordance with claim 10, further comprising:
receiving media content from the network after access to the network has been provided by the access point.

12. The method in accordance with claim 10, wherein the media device and the access point communicate using the WISPr protocol.

13. The method in accordance with claim 10, wherein the instructions specifying that advertisement data be selected is based on one or more rules that specify how the advertisement data should be selected.

14. The method in accordance with claim 13, wherein the one or more rules specify that the selected advertisement data be directed towards an advertiser that is not relevant to the location of the access point that provides access to the media device.

15. The method in accordance with claim 13, wherein the one or more rules specify that the advertisement data that is selected be relevant to the location of the access point that provides access to the media device.

16. The method in accordance with claim 13, wherein the advertisement data is selected based upon user profiles when there is no advertisement data stored in the memory that is in accordance with the received instructions.

17. The method in accordance with claim 10, further comprising
determining how long access to the network has been provided to the media device;
suspending access to network when it is determined that the media device has accessed the network more than a predetermined amount of time;
selecting subsequent advertisement data from the memory; and
reestablishing access to the network upon verification that the subsequent advertisement data has been viewed.

18. A media device configured to communicate with a network, the device comprising:
a memory;
a processing unit;
a connection module configured to communicate with a network access point; and
an advertisement module configured to select advertisement data in accordance with instructions received from the access point, wherein viewing the selected advertisement data allows access to be granted by the access point to a network without the need for a prior form of payment.

19. The media device in accordance with claim 18, wherein the instructions specifying that advertisement data be selected is based on one or more rules that specify how the advertisement data should be selected.

20. The media device in accordance with claim 18, wherein the media device is one of a satellite radio device, a portable audio player, a portable DVD or CD player, a personal computer, a laptop computer, a server computer, a cellular telephone, a personal digital assistant (PDA), or any combination thereof.
